(19) United States
(12) Patent Application Publication
(10) Pub. No.: US 2018/0081356 A1
(43) Pub. Date: Mar. 22, 2018

(54) MULTIROTOR GAME SYSTEM

(71) Applicant: The Geek Group, Grand Rapids, MI (US)

(72) Inventors: Christopher A. Boden, Grand Rapids, MI (US); Paul E. Kidwell, St. Clair Shores, MI (US); Samuel M. Clarke, Holland, MI (US)

(21) Appl. No.: 15/699,569

(22) Filed: Sep. 8, 2017

Related U.S. Application Data
(60) Provisional application No. 62/396,422, filed on Sep. 19, 2016.

(51) Int. Cl. G05D 1/00; A63F 13/213; A63F 13/30; A63F 13/25; G06T 11/60; G06K 9/00

(52) U.S. Cl. CPC G05D 1/0038; A63F 13/213; A63F 13/30; A63F 13/25; G06T 11/60; B64C 39/024; G05D 1/0027; B64C 2201/024; B64C 2201/146; B64C 2201/12; G06K 9/0063

(57) ABSTRACT

A system enabling remote-controlled piloting of multirotors with first-person-video to play games. Each multirotor has a transmission system and a detection system. The transmission system acts as a gun that transmits an electromagnetic radiation signal and the detection system acts as a shot detector by detecting the electromagnetic radiation signal. Game information can be processed and overlaid on the first person video provided to the player piloting the multirotor. Each multirotor may include a lighting system and a LASER to provide visual cues to other players and observers. Some embodiments utilize flag devices in a capture-the-flag game mode.

### BACKGROUND OF THE INVENTION

The present invention relates to unmanned aerial vehicles (UAVs).

Interest in unmanned aerial vehicles in the hobby market has increased greatly in recent years. Some attribute this growth to a number of UAV components becoming cheaper and smaller in recent years. For example, battery technology, cameras, GPS, inertial measuring units, and electronic compasses have all been miniaturized and become more affordable in recent years. What was once a difficult and frustrating hobby has become fairly accessible to anyone with a passion to take to the skies.

Many hobbyists prefer to “do something” with UAVs above and beyond flying them around. Some UAV owners have sought out interesting ways to compete with their vehicles. Classic methods of competition include racing and dogfighting. In the UAV hobby, dogfighting has traditionally been accomplished by attaching a long ribbon usually made of thin paper a couple inches wide and 50 to 100 feet long trailing from the aft of the aircraft. The goal in dogfighting is to cut your opponents streamer with your propeller. After the end of the flight, the aircraft with the longest streamer wins the dogfight. This simple system has been used for over 50 years in the hobby.

Some have attempted to update dogfighting with laser tag technology by installing infrared transmitters and receivers on radio-controlled model aircraft systems. In one system, a transmitter on an RC aircraft emits an infrared light beam. When the infrared beam is received a servo motor moves an arm which releases a model aircraft door behind which there are ribbons. The ribbons escape from the aircraft wings to show a hit. Dogfighting with these RC aircraft has a variety of issues. For example, there are a limited number of hits available due to the physical ribbon, there is no provision for in flight recovery after a hit or returning to the game after being declared “dead”.

In recent years, new UAV technology has led to the creation of an entirely new form of UAV called a multirotor. A multirotor UAV is a rotorcraft with more than two or more rotors. The names tricopter, quadcopter, hexacopter and octocopter are sometimes used to refer to 3-, 4-, 6- and 8-rotor helicopters, respectively. Multirotors typically control motion by varying the relative speed of each rotor to change the thrust and torque produced by each.

In many multirotors, mechanical gyroscopes have been replaced with inertial measuring units, electric motors have increased efficiency and power levels, and LiPo batteries have evolved to be able to output over thirty-times their charge rating for up to ten minutes. Although multirotors are more accessible and easier to control, conventional dogfighting does not work well with the newer multirotor crafts. In addition, known UAV dogfighting has other issues such as not being easy to spectate and being too strategically simplistic. New advances in hobby rotorcrafts that address these and other issues are desired.

### SUMMARY OF THE INVENTION

The present invention provides a system for remotely controlling a multirotor unmanned aerial vehicle (UAV). The system includes a multirotor UAV and a multirotor UAV remote control system. The multirotor UAV is equipped with an electromagnetic radiation transmission system, an electromagnetic radiation detection system, a camera, and a multirotor UAV communication system. The multirotor UAV remote control system includes a control communication system that wirelessly communicates with the multirotor UAV communication system, a display that displays multirotor UAV video information based on output from the camera and that displays video overlay information based on one or both of the electromagnetic radiation transmission system and the electromagnetic radiation detection system. The system also includes a remote controller with a human interface that accepts inputs to control operation of the multirotor UAV including activation of the electromagnetic radiation transmission system.

In one embodiment, the electromagnetic radiation detection system includes separate electromagnetic radiation detectors installed on the multirotor UAV. The video overlay information can indicate a direction of received electromagnetic radiation emission based on output from the electromagnetic radiation detectors. The multirotor UAV can include a lighting system that activates in response to the electromagnetic radiation detection system receiving an electromagnetic radiation signal.

In one embodiment, the multirotor UAV can update video overlay information in response to the electromagnetic radiation detection system receiving an electromagnetic radiation signal or in response to electromagnetic radiation transmission system activation. For example, offensive information can be updated on the video overlay such as virtual ammunition and defensive information can be updated on the video overlay such as virtual health or shields. Further, an electromagnetic radiation signal may be encoded with a multirotor UAV identifier and the video overlay information can be updated based on that identifier, for example, to indicate the origin of the UAV electromagnetic radiation signal.

In another embodiment, the electromagnetic radiation transmission system includes an infrared (IR) transmitter and a visible-light LASER. The IR transmitter and the visible-light LASER activate simultaneously in response to input from said human interface of said remote controller. The IR transmitter and the visible-light LASER can be configured to generate signals along parallel signal paths such that the visible-light LASER generates a human-visible indication of the signal output from said IR transmitter.

In another aspect of the invention, a multirotor UAV game system includes multiple multirotor UAVs each equipped with an electromagnetic radiation transmission system, an electromagnetic radiation detection system, a camera, and a multirotor UAV communication system. The game system also includes multiple multirotor UAV remote control systems each associated with one of the multirotor UAVs.

Each of the multirotor UAV remote control systems includes a control communication system for wirelessly communicating with the associated multirotor UAV, a display that displays first-person-video information based on output from the camera of the associated multirotor UAV and that displays video overlay information based on at least the electromagnetic radiation transmission system or the electromagnetic radiation detection system of the associated multirotor UAV. The multirotor UAV remote control systems also include a remote controller that includes a human interface that accepts inputs to control operation of the associated multirotor UAV including activation of the electromagnetic radiation transmission system of the associated multirotor UAV.

The game system can include two or more flag devices for implementing a multirotor UAV capture the flag game, each flag device has an electromagnetic radiation detection system and an electromagnetic radiation transmission system. Each flag device can be configured to activates its electromagnetic radiation transmission system to generate a flag device electromagnetic radiation signal in response to receiving an electromagnetic radiation signal and decoding a predefined multirotor UAV identifier. Further, each multirotor UAV, in response to receiving a flag device electromagnetic radiation signal can reconfigure its electromagnetic radiation transmission system to output a different electromagnetic radiation signal.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 illustrates one embodiment of a functional block diagram for a multirotor UAV game system.

FIG. 2 illustrates one embodiment of a circuit diagram of a circuit board included in a multirotor UAV game system.

FIGS. 2A-E illustrate close-up views of portions of FIG. 2.

FIG. 3A illustrates a perspective view a quadcopter with game components installed.

FIG. 3B illustrates an exploded view of the quadcopter.

FIG. 3C illustrates a close-up view of a portion of the circuit board of the quadcopter.

FIG. 4 illustrates one embodiment of a screenshot on the display.

FIG. 5A illustrates a perspective view of one embodiment of a flag device.

FIG. 5B illustrates an exploded view of the flag device.

FIG. 6A illustrates a perspective view of two quadcopters and a display.

FIG. 6B illustrates a perspective view of two quadcopters and their respective associated displays.

FIG. 6C illustrates a perspective view of two quadcopters and an associated display.

FIG. 7A illustrates a perspective view of a quadcopter in proximity to a flag device and the associated display of the quadcopter.

FIG. 7B illustrates a perspective view of a quadcopter in proximity to a flag device and the associated display of the quadcopter.

FIG. 7C illustrates a perspective view of a quadcopter in proximity to a flag device after the flag is shot.

FIG. 8A illustrates a team 1 quadcopter shooting a team 2 flag device.

FIG. 8B illustrates a plurality of team 1 quadcopters in proximity to the team 2 flag device receiving a flag signal.

FIG. 8C illustrates a perspective view of a team 2 quadcopter shooting a team 1 quadcopter and dropping the flag.

FIGS. 9A-B illustrates a quadcopter shooting a friendly flag device to score.

FIG. 10 illustrates a quadcopter shot direction diagram.

FIGS. 11A-B illustrate one embodiment of a quadcopter menu flow diagram.

FIG. 11C illustrates one embodiment of an on-screen display for the quadcopter.

FIG. 11D illustrates one embodiment of a flag device menu flow diagram.

### DESCRIPTION OF THE CURRENT EMBODIMENT

The current embodiment of the present invention is directed to a multirotor game system. Players remotely pilot multirotor UAVs using remote controllers and first-person-video (“FPV”) displays. A variety of different games can be played using the game system in which players shoot (transmit electromagnetic radiation) at one another's multirotors or other game objects using the electromagnetic transmission system installed on each multirotor.

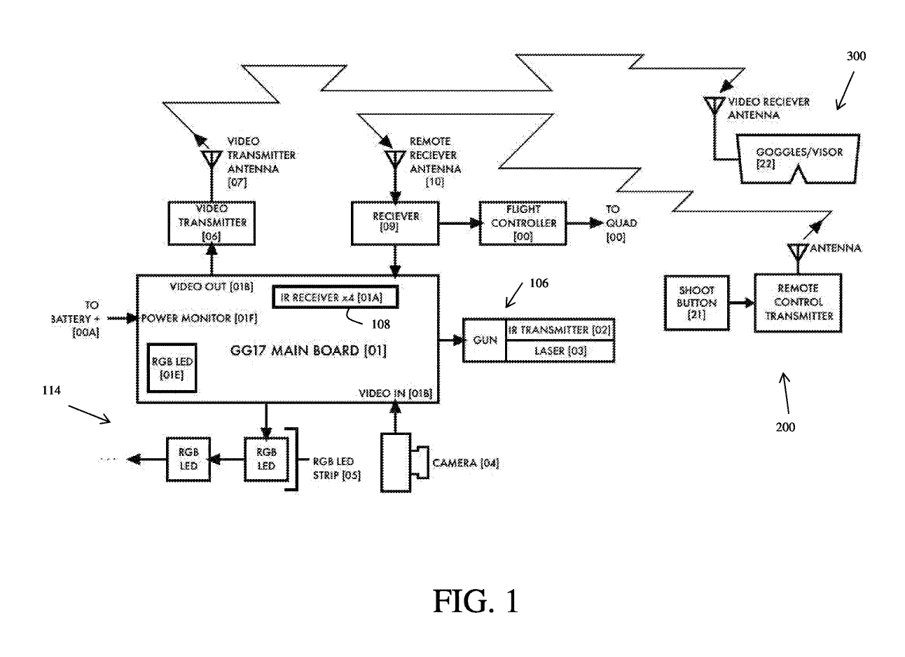

Perhaps as best shown in FIG. 1, each multirotor can have a variety of different game components installed. These quadcopter game components can communicate wirelessly with a display 300 and/or a remote control 200 associated with that multirotor. The display 300 and remote control 200 can be separate pieces of hardware or integrated into a single device. Although the depicted embodiment in the figures is directed to quadcopters that each have four rotors, in alternative embodiments tricopter, hexacopters, or other multirotor crafts can be used instead of or in addition to the quadcopters.

As each quadcopter flies, it can stream video wirelessly to an associated display 300, providing a first-person-view from the quadcopter perspective to the operator. The quadcopter can also wirelessly transmit game information to the associated display 300, which can overlay the streaming video in the first-person-view (FPV) display 300. In one exemplary FPV display, offensive game information such as virtual ammo and defensive game information such as virtual shields can be displayed in the FPV display.

The player can control the quadcopter using an associated remote control by transmitting wireless control signals to the quadcopter. These signals can include navigation signals that steer and operate the quadcopter itself as well as game signals. For example, one game signal is a shoot signal, which activates the electromagnetic transmission system 106 to fire the IR transmitter 02 and LASER 03 from the quadcopter.

There are a variety of different game components installed on the quadcopter in the depicted in the illustrated embodiment. In alternative embodiments, additional or fewer game components can be installed on the quadcopter. In the depicted embodiment, the quadcopter game components include a circuit board 01, a camera 04, an electromagnetic transmission system 106, an electromagnetic receiver system 108 (in this case installed directly on the circuit board 01), a communication system (i.e. a video transmitter 06, video transmitter antenna 07, receiver 09, and remote receiver antenna 10), a battery 00A, and a lighting system 05. Some or all of these components can be retrofit onto an off the shelf quadcopter or alternatively some or all of these components can be integrated during manufacture of a quadcopter or other multirotor craft.

Each quadcopter is equipped with an electromagnetic transmission system 106. In the depicted embodiment the electromagnetic transmission system 106 includes an infrared (IR) transmitter 02 and a visible-light LASER 03.

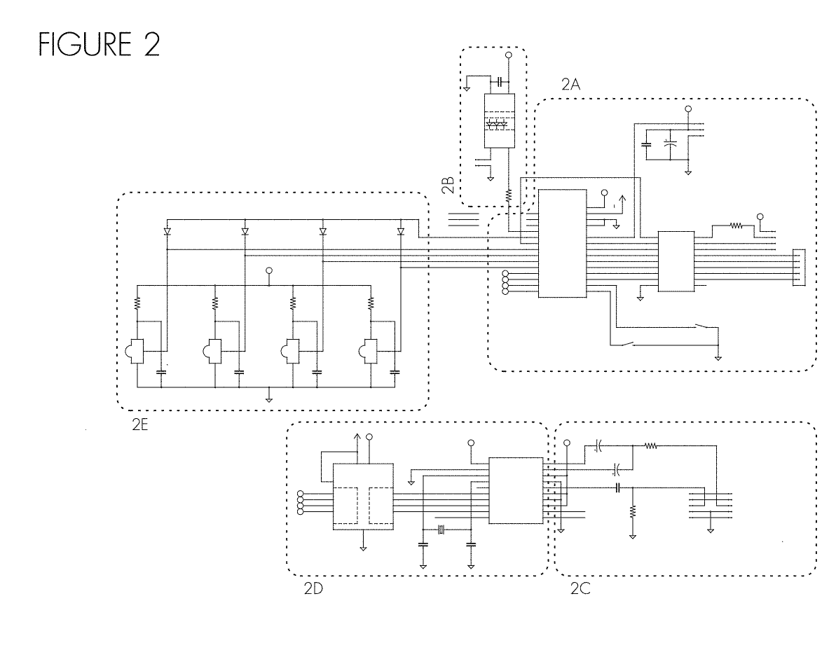

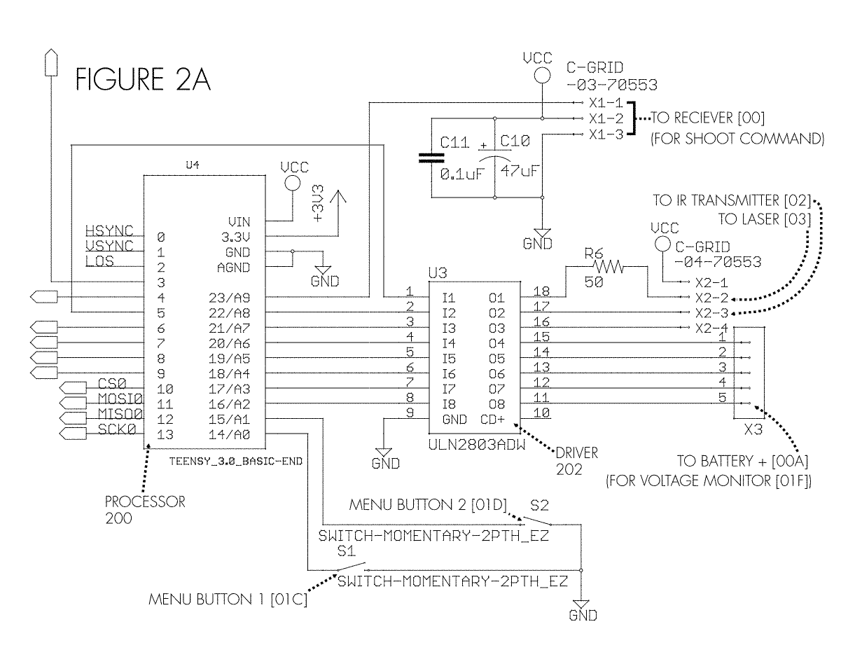

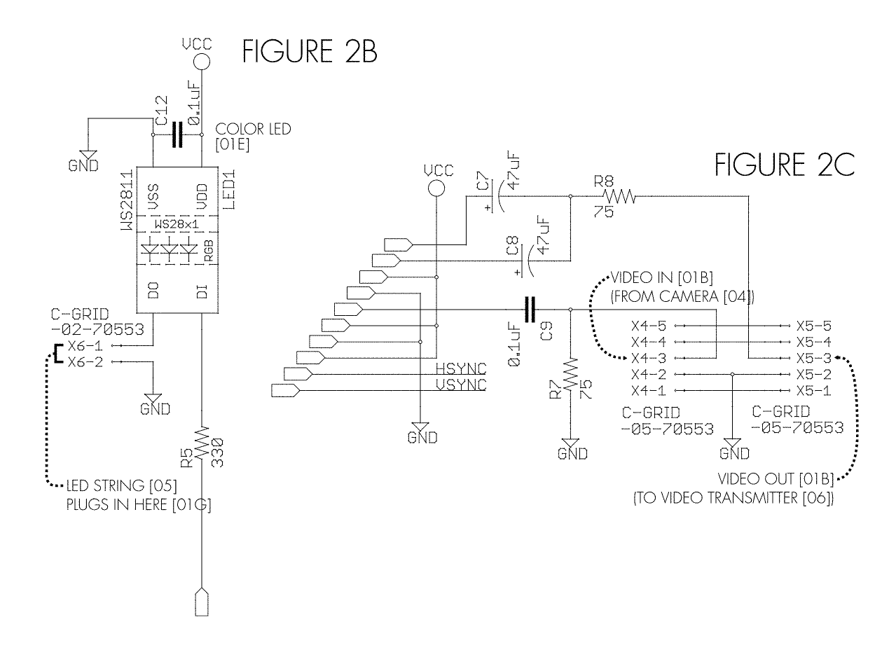

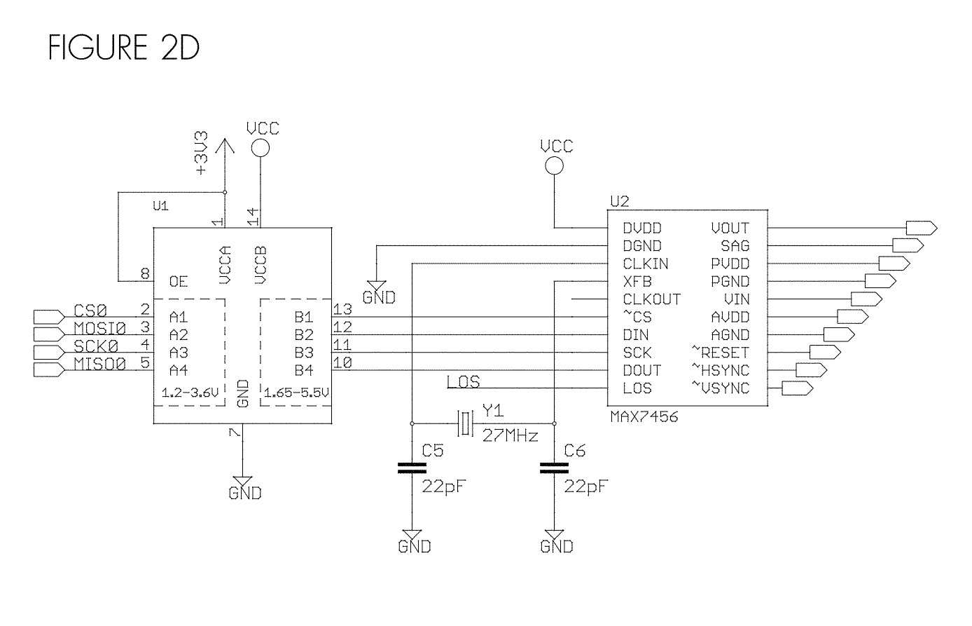

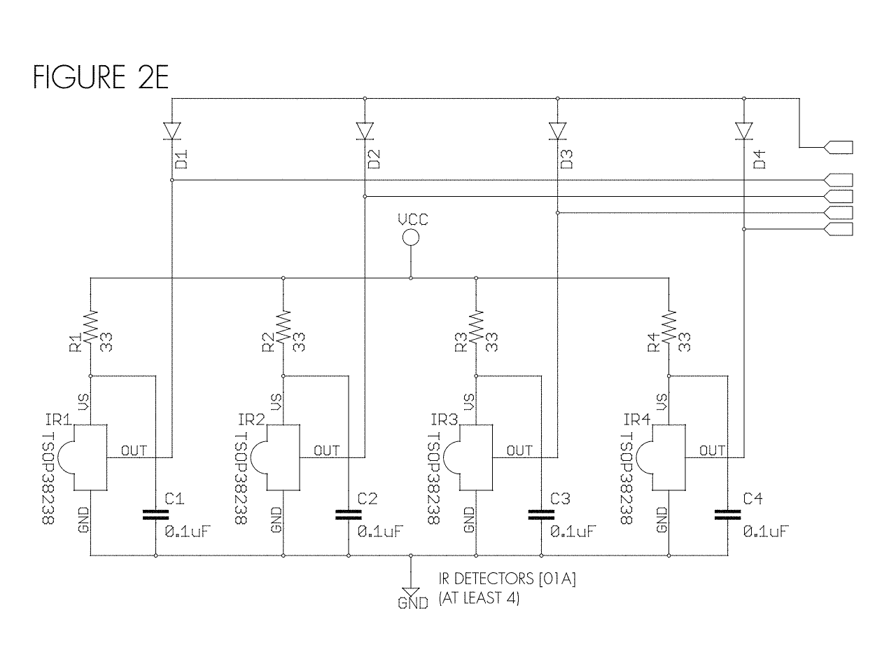

The IR transmitter 02 and the visible-light LASER 03 are configured to simultaneously activate in response to a shoot signal from an associated remote control 200. Essentially any off the shelf IR transmitter and LASER can be configured to work with the game system. The IR transmitter 02 emits an infrared signal that can be detected by an electromagnetic detection system 108 installed on another quadcopter (such as the one or more IR detectors 01A depicted in FIG. 2 and FIG. 2E). The IR signals may be difficult or impossible to see with the human eye either as a spectator watching the quadcopter game in the sky or a player or spectator watching via an FPV display 300. The visible-light LASER 03 that is activated simultaneously with the IR transmitter 02 provides a visual indication of the quadcopter shot for the players and spectators. The IR transmitter and said visible-light LASER are configured to generate signals along parallel signal paths. In this way, the visible indication created by the LASER when it strikes the UAV or surrounding terrain acts as an indication for the IR signal that is not visible to the human eye. This can be beneficial because without a visual indication of the quadcopter shot, neither players nor spectators can easily discern how close or where missed shots went. As an alternative, an 802.11 WiFI network could be established between the UAV's, flags, and a combat monitor that could oversee the game and provide real time feedback to the players and spectators.

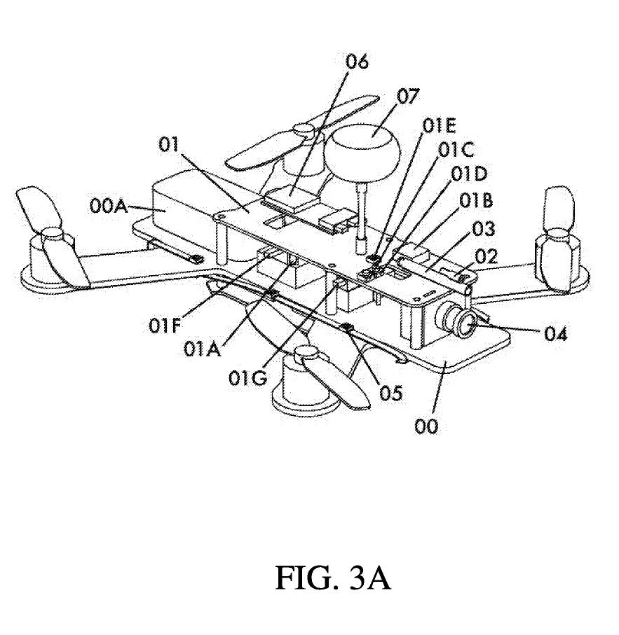

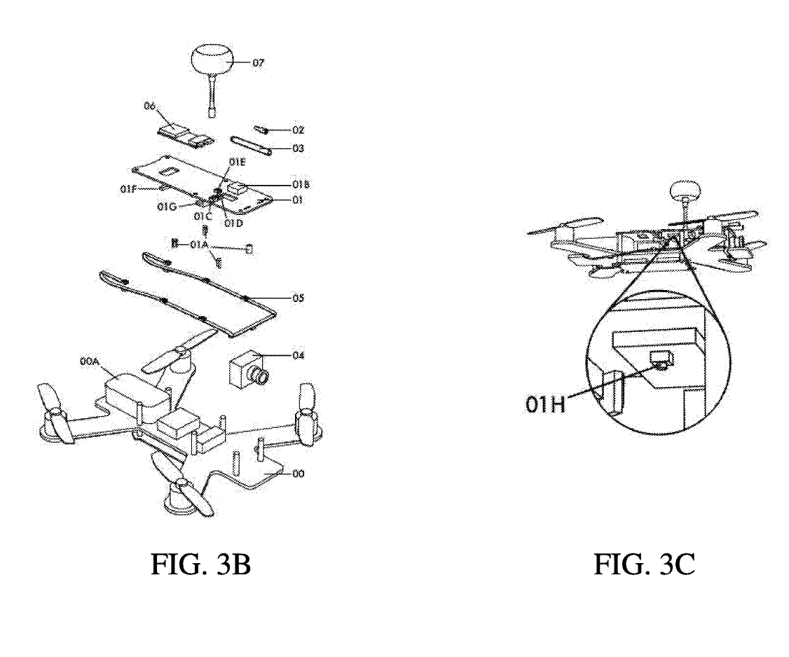

Each quadcopter is also equipped with a detection system. In the current embodiment, each quadcopter is equipped with an electromagnetic radiation detection system 108 that includes four or more IR detectors installed around the perimeter of the quadcopter. The position and orientation of the IR detectors 01A in one embodiment are shown in FIGS. 3A and 3B. The depicted position and orientation enables the quadcopter to determine the direction from which a received IR transmitter signal originated. In the current embodiment, the IR detectors are binary detecting the presence or absence of an IR signal. In alternative embodiments, the IR detectors may detect the strength of the IR signal. In the current embodiment, the direction of the IR signal is determined based on how many and which IR detectors detect the presence of an IR signal. The processor or other circuitry configured to ascertain the direction of the IR signal or other game information from the output of the detection system can be located on the quadcopter or remotely, for example in the display 300 or remote controller 200.

The IR signal received by the IR detectors 01a may be encoded with information such as a quadcopter identifier, team identifier, or other game information. In the current embodiment, the processor 200 installed on the main board 01 can decode received IR signals and provide game information to the display 300 associated with the quadcopter. This enables the quadcopter to wirelessly transmit and display to the player meaningful game information such as an indication of the origin of the IR signal received by the quadcopter including the direction from which the IR signal was received. The video overlay circuitry 01b, depicted in FIG. 2 and FIG. 2C can create a video stream with the game information overlaid on top of the first person video from the camera 04 of the quadcopter.

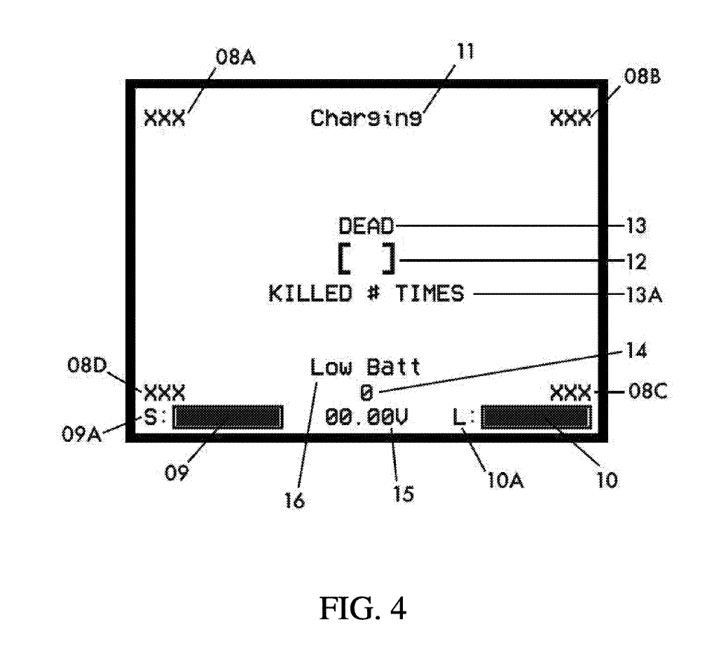

One example of a video overlay is depicted in FIG. 4. The overlay shows the various pieces of information that can be overlaid on the FPV video display 300. In the current embodiment, this includes shot indicators 08A-08D, shields/hit point/damage meter 09, a meter label 09a, a laser/ammunition meter 10, a meter label 10a, a charging/shooting indicator 11, crosshairs or reticle 11, a dead or flag indicator 13, a number of times “killed” indicator 13a, an indicator of Player ID that shot 14, voltage remaining on battery indicator 15, a low battery warning indicator 16. In alternative embodiments, additional, less, or different information can be included on the overlay.

Shot indicators 08A, 08B, 08C, and 08D assist the player in quickly assessing the direction from which they are being shot. These shot indicators correspond to the position of the respective IR detectors installed on the quadcopter. For example, in the current embodiment, the 08A shot indicator indicates a signal received by the front-left IR sensor, the 08B shot indicator indicates a signal received by the front-right IR sensor, the 08C shot indicator indicates a signal received by the rear-right IR sensor, and the 08D shot indicator indicates a signal received by the rear-left IR sensor. In the current embodiment, the rear sensors are angled to look forward and outward at a 45 degree angle. The front sensors are angled to look backwards and outward at a rear facing 45 degree angle. The software running on the UAVs game processor is capable of keeping track of which sensor is looking where, which can provide a bit of overlap in coverage to the sides.

FIG. 10 shows a representative diagram of various quadcopter shots and sample overlay views indicating the direction of the shots. Specifically, FIG. 10 illustrates eight different directions that can be detected using four IR detectors and how that information can be overlaid into a user's display. In the FIG. 10 example, there are four IR detectors positioned around the quadcopter and each IR detector detects a signal in one of four quadrants. For example, a shot toward the front of the rotorcraft where the camera is located can be shown by turning on or illuminating the front-left shot indicator 08A and the front-right shot indicator 08B. Further, a shot from the front-left can be displayed on the display by turning on the front-left shot indicator 08A. Alternatively, a front-left shot can be displayed by turning on the front-left shot indicator 08A, front-right shot indicator 08B, and the rear-left shot indicator 08D. Alternative embodiment multirotor crafts can include additional or fewer IR sensors and corresponding shot indicators to display the origin of any received signals. In some embodiments the number of IR sensors may outnumber the number of indicators installed on the quadcopter, and vice versa.

Referring back to FIG. 4, the overlay can also include information regarding shields, hit points, or damage. Shields, which can be referred to as hit points or a damage meter, refer to the number of IR transmitter shots a quadcopter can receive before a deactivation event. A deactivation event can take a number of different forms. For example, it may refer to deactivation of the IR transmission system for the rest of the game round, a predetermined time in which the IR transmission system is deactivated, or another game repercussion event that penalizes the player. In the current embodiment, each time the quadcopter is shot, the shields on the quadcopter reduce. This is conveyed to the player through the overlay by the shield meter decreasing with each shot. In the current embodiment, the shields regenerate over time, so if a player can avoid being hit the shields will eventually recharge—in alternative embodiments, the shields do not recharge at all. In the current embodiment, activation of the IR transmitter halts charging of the shields, in alternative embodiments the IR transmitter activation may instead change the rate of shield recharge or not effect shield recharging, have an effect. The functionality of the shield meter and what happens when the shields reach zero is under software control from the game processor on board the UAV. Penalties for being killed could be as drastic as having a complete white out or partial obscuring of the FPV video display for some number of seconds. This would probably result in a crash.

The overlay in FIG. 4 also includes information regarding lasers or ammunition. This meter refers to a virtual amount of ammunition the quadcopter has available. If the meter is empty, it will prevent further activation of the IR transmitter and deactivate the IR transmitter if it is currently active while the meter goes to zero. In the current embodiment, the ammunition recharges over time while the quadcopter is not activating its IR transmitter. In alternative embodiments, the laser meter can affect the lasers in other ways. For example, in one alternative embodiment, the IR signal can be encoded with information referring to an amount of damage and that amount of damage can vary depending on a variety of factors such as the ammunition meter (for example, additional damage if the meter is full) or based on the shield meter (for example, a lower shield meter reduces the amount of damage encoded on the IR signal). In another embodiment, the laser meter may only recharge by targeting and hitting that player's team flag.

Other pieces of game information can also be displayed on the overlay. For example, an indicator to tell whether the quadcopter is currently charging its shields and/or ammunition, whether the IR transmitter is currently activated, or neither. The overlay can also include a reticle 12 for targeting the IR transmitter. Information can be displayed on the overlay to let the player know when the player is dead (for example, shot a predetermined number of times) or is carrying a flag signal, which is utilized in some variant game modes discussed below. The overlay can display the number of times the quadcopter has been killed 13A in variants where the quadcopter returns to the game after a deactivation period upon death. The overlay can also indicate the player ID, sometimes referred to as the quadcopter ID or multirotor ID, of the opposing quadcopter that last successfully shot this quadcopter. Finally, in this embodiment, the overlay can also include battery information, such as the voltage remaining 15 and a low battery warning indicator 16.

Referring back to FIG. 1, in the current embodiment, each quadcopter is equipped with a camera 04 for capturing first person video, which is ultimately displayed to the player's associated display 300. The video stream from the camera can be modified with a graphic overlay to display game information. The modified video stream can be provided to the display 300 to provide the player with both FPV video from the point of view of the quadcopter and game information. Essentially any camera that can be mounted to the quadcopter can be utilized. The camera can have a number of configurable settings.

Each quadcopter includes a communication system. For example, in the current embodiment, each quadcopter includes a video transmitter 06, video transmitter antenna 07, receiver 08, and remote receiver antenna 10. The video transmitter and antenna can transmit the video stream and game information to a video receiver antenna on the display 300. Essentially any video transmitter and antenna can be configured to work with the system. The remote receiver and antenna can receive navigation and game signals from the remote control transmitter and antenna 200. Essentially any remote receiver 09 and antenna 10 can be configured to work with the system. In some embodiments, a single transceiver can handle both the communication with the display 300 and the communication with the remote controller 200.

Each quadcopter includes a power source such as a battery. A variety of different types and sizes of batteries can be used to power the various rotorcraft.

Perhaps as best shown in FIGS. 3A and 3B, each quadcopter may include a lighting system 05. The quantity of lights and the placement on the quadcopter can vary from craft to craft. The lights can be utilized for aesthetics and also to convey various game information. For example, the lights can be set to a particular color or respond with a predetermined pattern in response to detection of an IR signal. In one embodiment, the lights are color coded to indicate identity, for example team identity. A UAV's LEDs can be programmed to turn white when the UAV is hit by an opposing player, and flash white when the UAV is disabled or deemed “dead”.

The circuit board 01 of the depicted embodiment is a GG17 main board. Components on the circuit board can collect, processes, and transmit game information between various game components. Some of the game components may be installed directly on the main board, while others may be in communication with or through the circuit board. FIG. 2 and FIGS. 2A-E show a circuit diagram of one embodiment of the circuit board 01. The depicted circuit board includes a processor 200, a driver 202 for driving the electromagnetic transmission system 106, an electromagnetic detection system 108, video overlay circuitry 01B, onboard LED 01E, switches 01C, 01D, and a reset button 01H. FIG. 3C shows a close-up view of the location of the reset button. The processor also provides circuitry for connecting the lighting system 05 and the receiver 09.

The processor receives information from various game components. For example, the camera, the electromagnetic detection system 108, the electromagnetic transmission system 106, and the receiver 09 can all provide information to the processor. For example, in the current embodiment the CSO, MOSTO, MISCO, and SCKO signals are a serial data link (SPI) between the processor and video overlay chip. In the current embodiment, the electromagnetic detection system includes four IR detectors 01A. By processing the output from these IR detectors, the processor can determine the direction from which an IR signal is received. Further the receiver 09 provides a shoot command from a remote control, which is used to trigger activation of the electromagnetic transmission system 106.

The game rules can be programmed into the processor. For example, the processor tracks the information relating the shields and ammunition and can prevent the activation of the IR transmitter and laser if there is no virtual ammunition or if the quadcopter has been deactivated due to being hit while the shield meter was depleted. The processor can provide all data displayed on the FPV video system. For example, this may include hit direction, shield and laser meter values, battery level, low battery alert, number of times hit, color displayed by LEDs, codes sent by the IR LEDs, codes detected by the IR receivers, activation of the laser, and essentially any other game or system information.

There are a variety of different game modes that can be implemented with the multirotor UAV game system. Some of the game modes utilize additional objects besides the multirotor crafts. For example, one example is a capture-the-flag game mode that includes a flag device that can respond to an IR signal from an enemy quad copter by transmitting a flag IR signal, and can record a point when a friendly quadcopter transmits a flag signal to the friendly flag device.

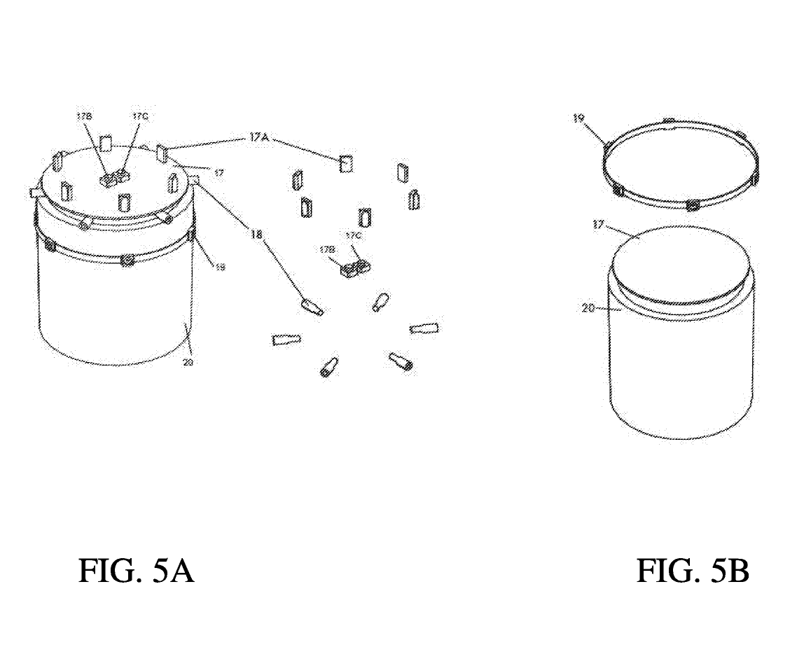

FIGS. 5A and 5B depict an exemplary flag device for use in some embodiments of a multirotor UAV game system. The depicted embodiment of the flag device includes a flag circuit board 17, six infrared detectors 17A, two menu buttons 17B, 17C, six IR emitters 18, and a lightning system 19 including 6 RGB LED light strings. The flag device can include a mount 20 for securing the flag device to an object such as a traffic cone, tripod, or other object to support the flag device at a desired height for the game system. The flag device can be associated with a quadcopter display or with its own individual display for configuration.

The flag device receives and decodes IR signals from the quadcopters and reacts differently to those signals depending on the information encoded in the IR signal. During the configuration of the game system, the quadcopters can be divided into teams associated with the flag devices. A friendly flag device is one associated with a friendly quadcopter identifier while an enemy flag device is one not associated with an enemy quadcopter identifier.

In the current embodiment of the capture the flag, the IR transmission signals in the game can be encoded with several pieces of game information. For example, each IR signal can be encoded with a category that identifies the signal as a damage signal or a flag signal. In response to receiving an IR signal from an enemy quadcopter, the flag device is configured to activate its IR emitters—in the depicted embodiment all 6 IR emitters. In this way, the flag device transmits a multi-directional IR signal. This signal is encoded with game information for enemy quadcopters indicating that its category is a flag signal (as opposed to a damage signal). Any enemy quadcopter that receives the IR signal from the flag device are configured to respond by encoding different game information into any further IR transmissions. That is each enemy quadcopter that receives this IR signal is configured to change transmission of IR signals encoded with a damage signal to instead be encoded with a flag signal category. In this way, quadcopters that receive an IR signal from an enemy flag device can no longer damage enemy quadcopters, but can score points by shooting a friendly flag device with the IR signal encoded with the flag signal. Quadcopters carrying the flag signal (that is configured to transmit IR signals encoded with the flag information) can be reconfigured to transmit IR signals encoded with the damage information after being shot or killed (i.e. shot a predetermined number of times or shot while virtual shield meter is empty) by an enemy quadcopter. Further, the quadcopter lighting systems can be reconfigured to display a predetermined lighting pattern (various colors and/or blinking patterns) in order to provide a visual indicator of the quadcopters carrying the flag signal.

There are a variety of different alternative embodiments. For example, in some game systems, receiving an IR signal encoded with flag information does not reconfigure your IR transmission signals to be encoded as flag signals, but rather reconfigures your IR transmission signals to be encoded with both damage and flag signals. In this variant, ships carrying the flag can still shoot at enemy quadcopters. In one embodiment, a hand held “gun” may be provided to spectators, whom can shoot UAVs that get too close. This could affect game play of the ongoing combat, or only record hits so spectators could play a concurrent game of competitive target shooting.

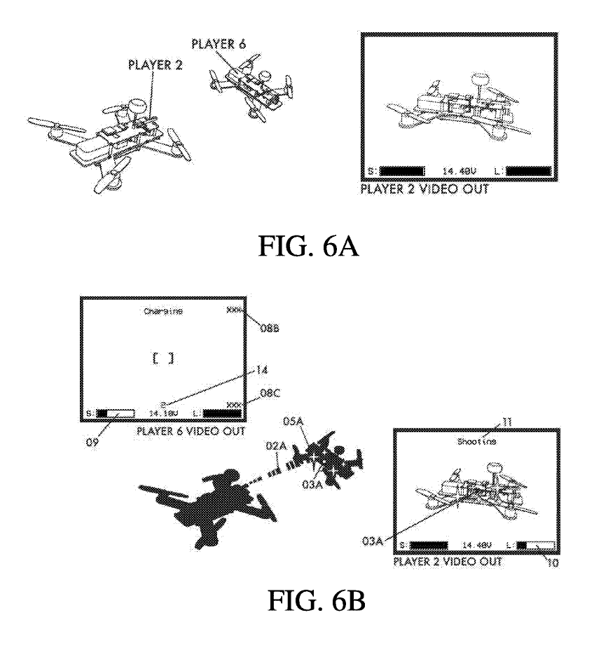

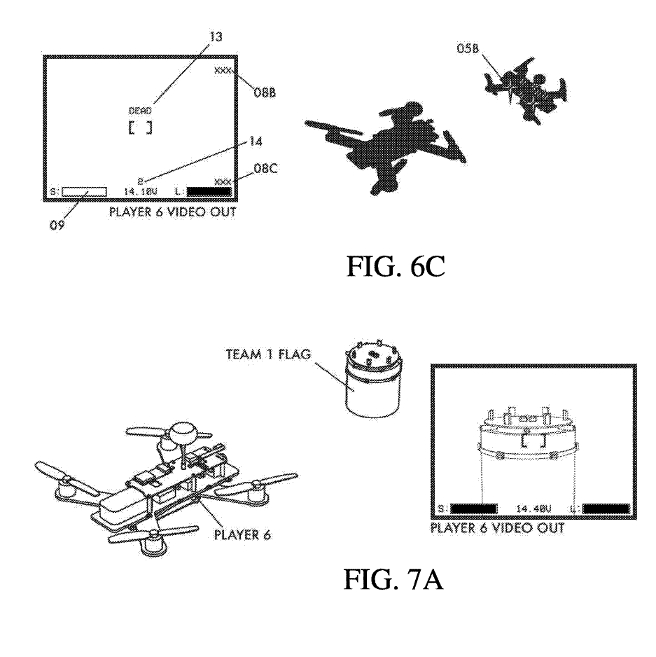

An example of air-to-air combat between two quadcopters in one embodiment of a multirotor UAV game system will now be described in connection with FIGS. 6A-C. FIGS. 6A-C show two multirotors participating in a multirotor game system, one with the quadcopter ID (referred to as Player 2) and one with the quadcopter ID 6 (referred to as Player 6). FIGS. 6A-C also includes screenshots of the display from the Player 2's perspective and Player 6's perspective.

As shown in FIG. 6B, as an operator presses the shoot button 21 on the remote control 200 associated with the Player 2 quadcopter, the Player 2 quadcopter LASER 03 and IR emitter 02 simultaneously activate. The IR emitter signal is transmitted toward the Player 6 quadcopter IR receivers 01A. The LASER dot 03A shows the Player 2 shot ‘hitting’ on the streaming video. Further, Player 2's display indicates they are shooting 11 and the display's ammo bar 10 depletes. In this embodiment, players can't ‘shoot’ continuously for more than a couple of seconds before the ammo bar becomes depleted and they must then wait for ammo bar to recharge. When the quadcopter is not shooting it is regenerating or charging both shields and ammunition as indicated by the indicator 11 displaying charging.

When ‘hit’, the quadcopter that was shot (Player 6 in this instance) can process the IR signal, decode game information, and communicate with an associated remote display 300 to display the following:
The direction the shot came from in 2D space (in alternative embodiments in 3D space).
Who shot (displays player ID number 14). Depending on the configuration of the game system, friendly fire can be turned or off. If it is off then shooting a teammates quadcopter will not have an effect and won't display ‘damage’ from players on the same team. The game system can still display the player ID number and the direction the shot came from.
How much ‘damage’ taken (in this example indicated by the depletion of the shield meter). In the current embodiment of the game system, it takes multiple shots to ‘kill’ a quad.
The quadcopters lighting system turns solid white, to show other players that it's taken ‘damage’.

FIG. 6C shows Player 2 successfully hit Player 6's quadcopter (or as another enemy quad shoots at Player 6). Once the quadcopter has been shot a sufficient number of times to deplete the shields/damage meter, the quad is deemed killed and displays the the following information on the associated display:
a “Dead” message 13;
the number of times this quadcopter has been ‘killed 13A; and
the quadcopter lighting system flashes white.

In the current embodiment, the quadcopter is dead (for example certain quadcopter components are deactivated or limited in functionality) for a certain amount of time. The amount of time can change depending on a variety of factors. For example, the more times that your quadcopter is killed in a round the timer may increase. During this deactivation period the IR emitter and laser do not react to players pressing the shoot button 21 and the quadcopter lighting system continues to flash white.

After the deactivate period, the quadcopter returns to functionality with full ‘shields’ and ‘ammo’ and the lighting system returns to normal. For example, in a team game the quadcopter lighting system may return to a solid color depending on the team.

After the game is over a score can be tabulated based on whose quadcopter was killed the least. In a free for all game, the winner is the quadcopter that was killed the least among all quadcopters, in a team game the winner is the team with the least deaths when the deaths of all quadcopters on each team are summed.

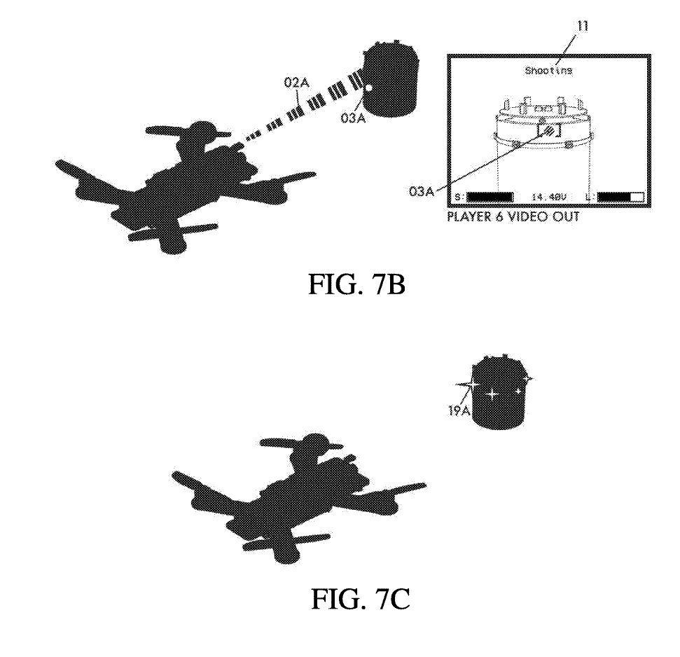

An example of one embodiment of a capture the flag game system will now be described in connection with FIGS. 7A-C. FIGS. 7A-C show a multirotor UAV (Player 6) engaging a flag device. FIGS. 7A-C also includes screenshots of the display from the Player 6's perspective.

The capture the flag game works similarly to the air-to-air combat game. That is, quadcopters can shoot at each other and accumulate kills that deactivate the enemy quadcopters. However, victory is not related to which team died the least, but instead which team captures the most flags.

In this example, Player 6 is on Team 1. Player 6's quadcopter flies toward Team 2's flag and as shown in FIG. 7A has visual sight of the Team 2 flag device on the display.

Player 6 presses shoot button 21, which activates the electromagnetic radiation transmission system including the LASER 03 and the IR emitter 02, as shown in FIG. 7B. The IR emitter transmits the shoot signal 02A to the flag device's IR detection system 17A. The LASER dot 03A shows Player 2's shot hitting the flag device. In the depicted embodiment, the IR emitter outputs a cone of IR, the diameter of the IR “spot” is rather large at maximum range. For example, some IR emitters can emit a circle as large as 36″ at a range of 50′.

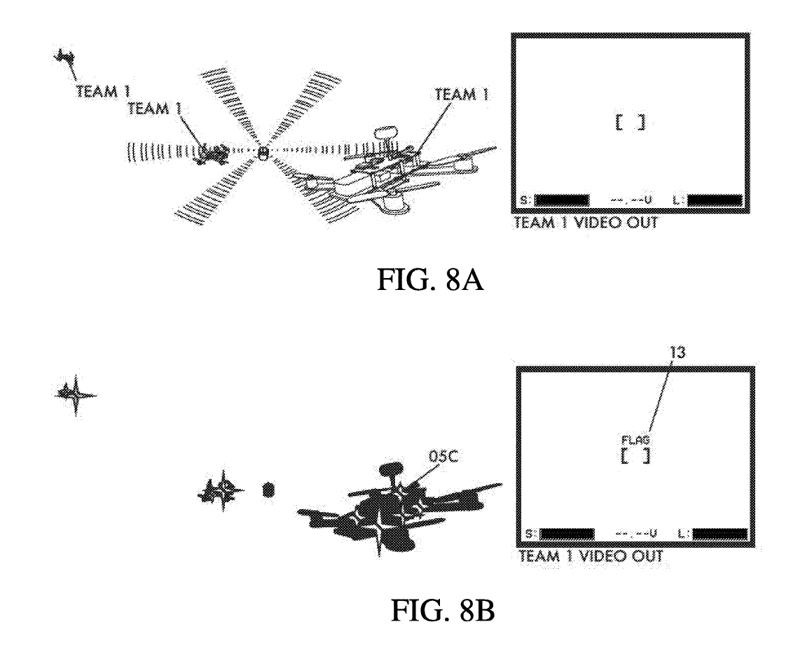

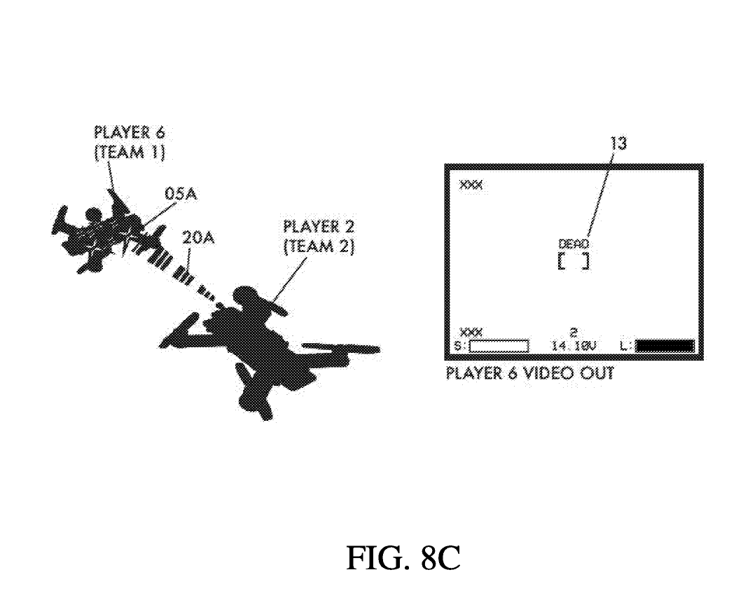

As shown in FIG. 7C, in response to receiving the IR signal from Player 6's quadcopter (or any other quadcopters on the enemy team) the Team 1 flag device's lighting system 19a flashes. In addition, as shown in FIG. 8A, the Team 2 flag device's ring of IR emitters 18 activates for a predetermined amount of time such as 1-2 seconds. This essentially generates an IR signal in the general vicinity of the team 2 flag—in the current embodiment about a 6 meter radius from the flag device. Any IR receives on Team 1 quads in that area that receive the IR signal can respond, as shown in FIG. 8B, by:
Flashing their lighting system continuously (until point scored or the flag is lost); this shows other players (on both teams) which quadcopters have a flag; and
Displaying on the quadcopter's associated display a message indicating they have received a flag signal.

In this example, each team 1 quadcopter that received the IR signal from the enemy flag reconfigures its quadcopter transmitter to shoot an encoded IR signal with flag information.

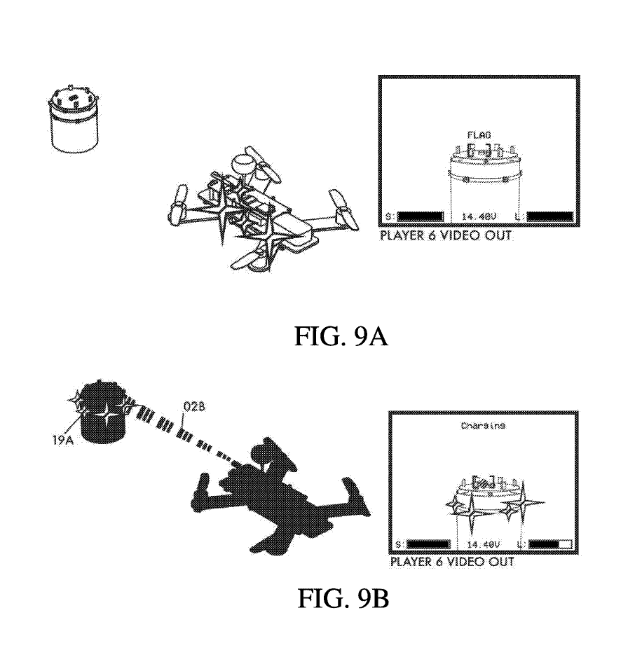

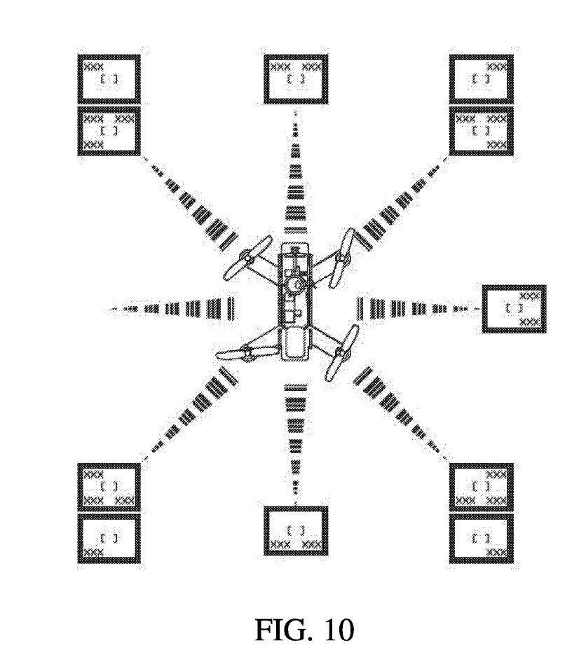

As shown in FIG. 9A, a Team 1 player with the Team 2 flag (e.g. Player 6 in this example) flies toward the Team 1 flag and ‘shoots’ the IR detector on the Team 1 Flag to score. The IR signal emitted by the Team 1 quadcopter with a flag sends a different IR signal than without the flag, as represented in FIG. 9B. That is, the signal has information encoded that indicates the IR signal originated from Player 6 on Team 1 (or indicates Player 6 and the flag device has stored in memory which player IDs are associated with which team), who has a flag, is shooting. As shown in FIG. 9B, In response to receiving such a signal, the team 1 flag records a point in memory and flashes its lighting system to indicate a point was scored.

In the depicted embodiment, if the player shoots and does not hit their own flag, the flag is lost, no point is rewarded, and the player's quadcopter reverts to shooting an IR signal that does not include the encoded flag information. Further, as depicted in FIG. 8C, if Player 6 (or any quadcopter carrying a flag signal) is shot and killed they also lose the flag, do not score a point, and revert to shooting an IR signal that does not include the encoded flag information. In this situation the quadcopter lighting system may flash white (instead of color) to show other players the quadcopter is dead and the flag has been lost.

In the current embodiment of the capture the flag game system, quadcopters do not have to complete a round trip before another team member collects another flag.

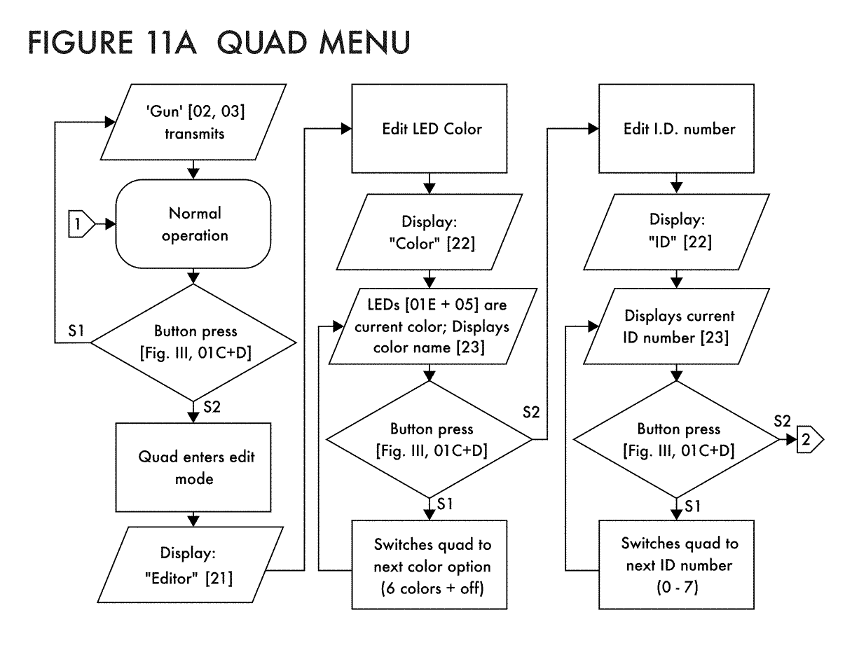

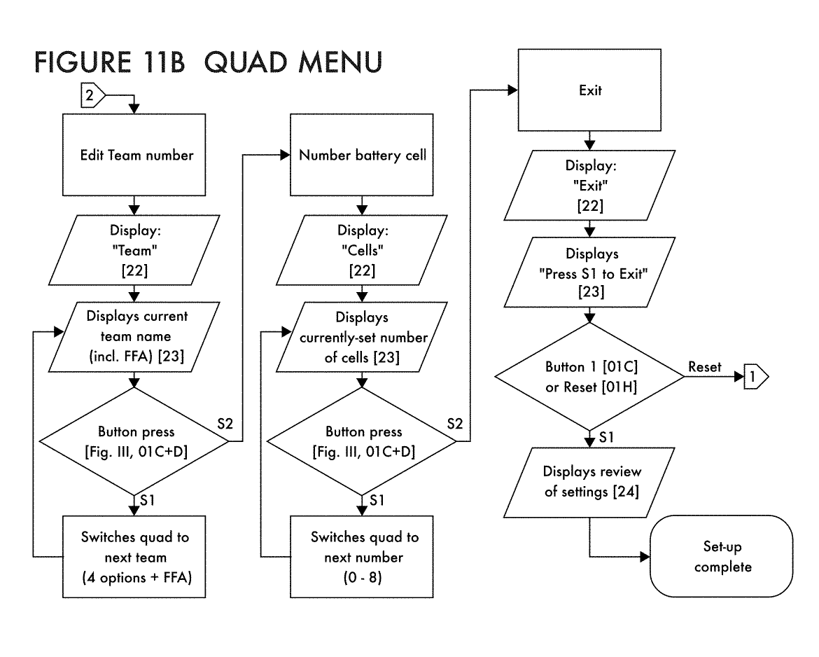

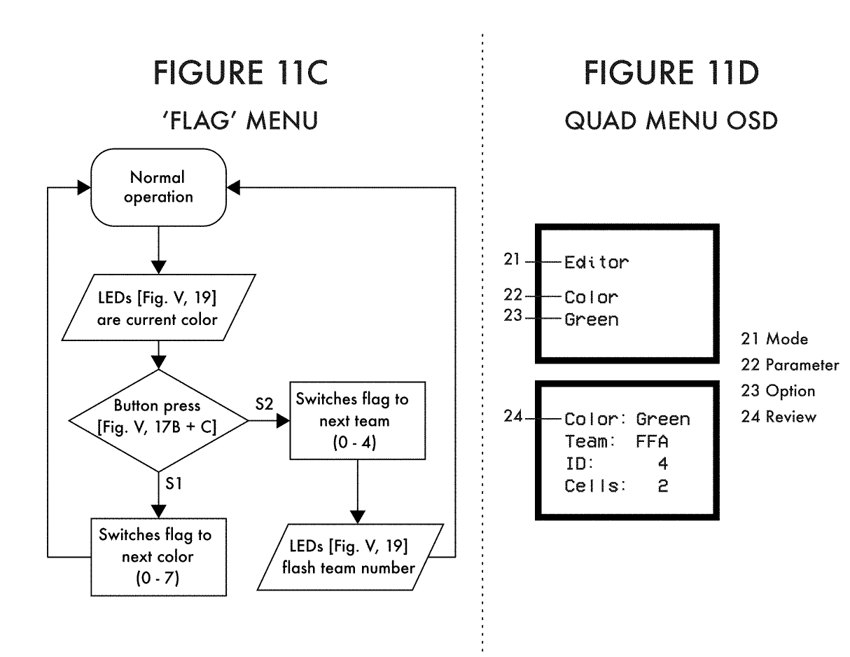

FIGS. 11A-B and 11C depict flowcharts for exemplary menu systems for a quadcopter and a flag device respectively. FIG. 11D shows the on screen display while configuring the quadcopter. A description of the configuration of a quadcopter will now be described in detail

After turning on the quadcopter, display and remote control, Players can use the quadcopter buttons 01C, 01D to configure the quadcopter through the menu displayed on the display 300 associated with that quadcopter. During normal operation, pressing 01C will fire the LASER and IR emitter as if a shoot command were received from the transmitter. This can allow easy testing to see that the laser and IR emitter are functioning properly. It can also be used to shoot at another quad to verify that the other quadcopter's IR receivers are working.

During normal operation, pressing the other button 01D will put the quad in “Editor” mode. This mode allows for the alteration of several software settings. When Editor mode is entered, “Editor” can be displayed on the on screen display of display 300. Below the word “Editor”, the OSD can display the particular parameter being altered, as shown in FIG. 11C. Pressing the 01C button will alter the displayed parameter while pressing the 01D button will advance the editor to the next parameter to edit.

In the current embodiment the editable parameters are
LED Color—Pressing 01C will cycle through off and six different colors that are displayed on the quad's RGB LEDs. In the current embodiment, the quadcopters can be configured to display solid lighting colors of Red, Green, Blue, Yellow, Purple, and Cyan. The lighting system can also be turned off. In this embodiment, White is reserved for game functionality and is not available as a quadcopter base color.
ID—Pressing 01C will cycle through seven different ID numbers. In one embodiment, the ID numbers are 0 through 7. In alternative embodiments, different, fewer, or additional ID numbers may be available.
Team Name—Pressing 01C will cycle through four different preset Team numbers/names. This can also be used to select a free for all game mode.
Cells—Pressing 01C will cycle through the number of cells in the quadcopter's battery. This number can be used by the circuit board's low battery level indicator to display accurate information about the battery. In the current embodiment, low battery is indicated when the battery voltage falls below 3.4 volts times the number of cells.

If playing a Capture the Flag game, each Flag device's buttons can be used to set the color and team number for that flag. The flag can be configured without an on screen display. In the current embodiment, the first flag button 17B selects LED 19 color. Flag color does not necessarily correlate to quadcopter colors. Further, the other flag button 17C can be used to set the team number. As the button 17C is pressed, the LEDs 19 flash a number of times to indicate selection (e.g. twice for team 2, three times for team 3, etc.).

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A system for remotely controlling a multirotor unmanned aerial vehicle (UAV) comprising:
a multirotor UAV equipped with an electromagnetic radiation transmission system, an electromagnetic radiation detection system, a camera, and a multirotor UAV communication system; and
a multirotor UAV remote control system including:
a control communication system for wirelessly communicating with said multirotor UAV communication system;
a display that displays multirotor UAV video information based on output from said camera and that displays video overlay information based on at least one of said electromagnetic radiation transmission system and said electromagnetic radiation detection system;
a remote controller that includes a human interface, said human interface accepts inputs to control operation of said multirotor UAV including activation of said electromagnetic radiation transmission system.

2. The system for remotely controlling a multirotor UAV of claim 1 wherein said electromagnetic radiation detection system includes a plurality of separate electromagnetic radiation detectors installed on said multirotor UAV and wherein said video overlay information indicates a direction of received electromagnetic radiation emission based on output from said plurality of separate electromagnetic radiation detectors.

3. The system for remotely controlling a multirotor UAV of claim 1 wherein said electromagnetic radiation transmission system includes an infrared (IR) transmitter and a visible-light LASER, wherein said IR transmitter and said visible-light LASER activate simultaneously in response to input from said human interface of said remote controller.

4. The system for remotely controlling a multirotor UAV of claim 3 wherein said IR transmitter and said visible-light LASER are configured to generate signals along parallel signal paths such that said visible-light LASER generates a human-visible indication of said signal output from said IR transmitter.

5. The system for remotely controlling a multirotor UAV of claim 1 wherein said multirotor UAV includes a lighting system that activates in response to said electromagnetic radiation detection system receiving an electromagnetic radiation signal.

6. The system for remotely controlling a multirotor UAV of claim 1 wherein said multirotor UAV updates video overlay information in response to said electromagnetic radiation detection system receiving an electromagnetic radiation signal.

7. The system for remotely controlling a multirotor UAV of claim 1 wherein said multirotor UAV updates video overlay information in response to said electromagnetic radiation transmission system activation.

8. The system for remotely controlling a multirotor UAV of claim 1 wherein said multirotor UAV includes a human interface for changing quadcopter configuration settings including at least one of a lighting configuration, multirotor UAV identifier, multirotor UAV game mode, and battery configuration.

9. The system for remotely controlling a multirotor UAV of claim 1 wherein said electromagnetic radiation detection system receives an electromagnetic radiation signal encoded with a multirotor UAV identifier and wherein said video overlay information is updated based on said multirotor UAV identifier.

10. A multirotor unmanned aerial vehicle (UAV) game system comprising:
a plurality of multirotor UAVs each equipped with an electromagnetic radiation transmission system, an electromagnetic radiation detection system, a camera, and a multirotor UAV communication system; and
a plurality of multirotor UAV remote control systems each associated with one of said plurality of multirotor UAVs, each of said plurality of multirotor UAV remote control systems including:
a control communication system for wirelessly communicating with said associated multirotor UAV;
a display that displays first-person-video information based on output from said camera of said associated multirotor UAV and that displays video overlay information based on at least one of said electromagnetic radiation transmission system and said electromagnetic radiation detection system of said associated multirotor UAV;
a remote controller that includes a human interface, said human interface accepts inputs to control operation of said associated multirotor UAV including activation of said electromagnetic radiation transmission system of said associated multirotor UAV.

11. The multirotor UAV game system of claim 10 wherein each of said multirotor UAV electromagnetic radiation detection systems include a plurality of separate electromagnetic radiation detectors and a processor, and in response to receiving an electromagnetic radiation signal said processor in each multirotor UAV determines a direction of said received electromagnetic radiation signal based on output from said plurality of separate electromagnetic radiation detectors installed on that multirotor UAV and updates video overlay information for that multirotor UAV to indicate said direction of said received electromagnetic radiation signal for display on said multirotor UAV remote control system associated with that multirotor UAV.

12. The multirotor UAV game system of claim 10 wherein each electromagnetic radiation transmission system includes an infrared (IR) transmitter and a visible-light LASER, wherein each of said IR transmitter and said visible-light LASER activate simultaneously in response to input from said human interface of a remote controller.

13. The multirotor UAV game system of claim 10 wherein each of said plurality of multirotor UAVs includes a lighting system and wherein said lighting system activates in a predefined pattern in response to said electromagnetic radiation detection system receiving an electromagnetic radiation signal from another of said plurality of multirotor UAVs.

14. The multirotor UAV game system of claim 10 wherein each of said multirotor UAVs updates video overlay information in response to said electromagnetic radiation detection system receiving an electromagnetic radiation signal from another of said plurality of multirotor UAVs.

15. The multirotor UAV game system of claim 10 wherein each of said multirotor UAVs updates video overlay information in response to said electromagnetic radiation transmission system activation.

16. The multirotor UAV game system of claim 10 wherein each electromagnetic radiation transmission system generates an electromagnetic radiation signal, wherein said electromagnetic radiation signal is encoded with a multirotor UAV identifier that identifies the origin of said electromagnetic radiation signal.

17. The multirotor UAV game system of claim 16 wherein each multirotor UAV electromagnetic radiation detection system includes a processor capable of decoding said multirotor UAV identifier from said electromagnetic radiation signal and updating video overlay information based on said multirotor UAV identifier in response to receiving said electromagnetic radiation signal.

18. The multirotor UAV game system of claim 16 including two or more flag devices for implementing a multirotor UAV capture the flag game, each flag device having an electromagnetic radiation detection system and an electromagnetic radiation transmission system.

19. The multirotor UAV game system of claim 18 wherein each flag device, in response to receiving an electromagnetic radiation signal and decoding a predefined multirotor UAV identifier, activates said electromagnetic radiation transmission system to generate a flag device electromagnetic radiation signal.

20. The multirotor UAV game system of claim 19 wherein a multirotor UAV in response to receiving said flag device electromagnetic radiation signal reconfigures its electromagnetic radiation transmission system to output a different electromagnetic radiation signal.
